(19) United States
(12) Patent Application Publication
(10) Pub. No.: US 2004/0255771 A1
(43) Pub. Date: Dec. 23, 2004

(54) Negative pressure type booster device for hydraulic brake device

(76) Inventors: Kaoru Tsubouchi, Toyota (JP); Tomoyasu Sakai, Kariya (JP); Koichi Hashida, Kariya (JP); Takahiro Kiso, Chiryu (JP)

Correspondence Address: BURNS DOANE SWECKER & MATHIS L L P, POST OFFICE BOX 1404, ALEXANDRIA, VA, 22313-1404, US

(21) Appl. No.: 10/859,976

(22) Filed: Jun. 4, 2004

(30) Foreign Application Priority Data
Jun. 6, 2003 (JP) 2003-162493

(51) Int. Cl. B60T 8/24

(52) U.S. Cl. 91/376 R

(57) ABSTRACT

An object of this invention is to smoothen the operation and stabilize the output of a negative pressure type booster device for a hydraulic brake device of the stroke-independent type, in which the brake operating force is amplified using negative pressure of an engine and the master cylinder is actuated using the amplified force. Airtight sealing between a power piston and a valve piston which is axially movable relative to the power piston, and between a plunger coupled to an input shaft and the valve piston are carried out by rolling seals to prevent inaccurate movement of the valve piston, which tends to occur when such airtight sealing is carried out using slide seals.

### BACKGROUND OF THE INVENTION

This invention relates to a negative pressure type booster device for a so-called stroke-independent type hydraulic brake device, in which the output and the output stroke are determined by the input, specifically a negative pressure type booster device for a hydraulic brake device in which smooth relative displacement between a valve piston provided on the input side and a power piston for outputting amplified force is possible so that stable output is obtainable.

A negative pressure type booster device for a stroke-independent hydraulic brake device used for braking of a vehicle is disclosed in JP 11-255103.

The negative pressure type booster device for a hydraulic brake device shown in “FIG. 9” of the patent publication includes a valve piston (valve body), a power piston provided concentric with the valve piston, a constant pressure chamber and a variable pressure chamber partitioned from each other by the power piston, and a shell forming the outer shell of the constant pressure chamber and the variable pressure chamber, an input shaft for transmitting the brake operating force, and a control valve for selectively bringing the variable pressure chamber into communication with the outside of the body shell and the constant pressure chamber. It is structured such that the output stroke changes according to the input.

When brake operating force is applied to the control valve through the input shaft, a vacuum valve of the control valve closes and an atmospheric valve opens. Thus, communication between the constant pressure chamber and the variable pressure chamber is shut off, and the variable pressure chamber communicates with the outside of the shell, so that atmospheric air flows into the variable pressure chamber. Thus, the pressure in the variable pressure chamber rises, so that a pressure difference is created between the constant pressure chamber and the variable pressure chamber, and the power piston, which receives the pressure difference on opposed pressure-receiving surfaces having different areas, produces an advancing thrust force, outputting amplified force.

The power piston and the valve piston, which, like the power piston, receives the pressure difference between the constant pressure chamber and the variable pressure chamber and produces an advancing thrust force, are combined so as to be movable in the axial direction relative to each other. By properly setting the spring forces of springs for returning the power piston, it is possible to reduce the operating stroke of the brake pedal relative to the stroke of the power piston.

Further, a reaction force piston is provided between the power piston and the valve piston, and when the pressure in the variable pressure chamber reaches a maximum pressure determined by the atmospheric pressure, i.e. when the booster function has ended and a full-load state is reached, the reaction force piston shuts off a second variable pressure chamber formed between the reaction force piston and the power piston from the variable pressure chamber to seal it.

The negative pressure type booster device for a hydraulic brake device shown in FIG. 9 of the patent publication 11-255103 performs airtight seal between the valve piston and the reaction force piston and between the reaction force piston and the power piston by providing slide seal members.

In the negative pressure type booster device for a hydraulic brake device shown in FIG. 9 of the patent publication, slide resistance is applied to the valve piston by the slide seal members, which are provided for airtight sealing. Due to the slide resistance, the moving force of the input shaft or the power piston is transmitted to the valve piston, so that the balance of the force applied to the valve piston is lost. Thus, the response of the valve piston for the brake operation by the driver becomes inaccurate, so that there were problems that during actuation of the brakes, the valve piston does not move to a predetermined position or its return is not reliably achieved when the brakes are released.

Further, it is desired that the valve piston is large in the area difference between the opposed pressure receiving surfaces (that is, the surface that receives the pressure in the constant pressure chamber and the surface that receives the pressure in the variable pressure chamber) in view of operating properties. But in the negative type booster device for a hydraulic brake device of the abovesaid patent publication, since the vacuum valve and atmospheric valve of the control valve are arranged coaxially, it was difficult to answer this requirement.

An object of this invention is to make it possible to smoothen the relative movement between the valve piston and the power piston to obtain a stable output.

### SUMMARY OF THE INVENTION

According to this invention, there is provided a negative type booster device for a hydraulic brake device comprising an input member, a power piston, a valve piston having a front end concentrically inserted in the power piston, a constant pressure chamber and a variable pressure chamber separated from each other by the power piston, a body shell forming the outer shell of the constant pressure chamber and the variable pressure chamber, and a control valve activated by brake operating force applied through the input member to selectively bring the variable pressure chamber into communication with the outside of the body shell and the constant pressure chamber, the control valve changing the pressure in the variable pressure chamber to a value corresponding to the input, thereby producing a pressure difference between the constant pressure chamber, which is connected to a negative pressure source, and the variable pressure chamber to amplify the output by applying the pressure difference to the power piston,

wherein the input member is coupled to a plunger, the plunger and the control valve are provided in the valve piston, the valve piston and the power piston are combined so as to be movable axially relative to each other such that each of them produces an advancing thrust force under the pressure difference between the constant pressure chamber and the variable pressure chamber, and the valve piston is biased in the retracting direction by an elastic repulsive member, and

wherein seals for airtight sealing are provided between the valve piston and the plunger and between the valve piston and the power piston, and each of the seals is formed of a rolling seal.

As another solution, there is provided a negative type booster device for a hydraulic brake device which is the same in prerequisite as the above,

wherein the input member is coupled to a plunger, the plunger and the control valve are provided in the valve piston, the valve piston and the power piston are combined so as to be movable axially relative to each other such that each of them produces an advancing thrust force under the pressure difference between the constant pressure chamber and the variable pressure chamber, and the valve piston is biased in the retracting direction by an elastic repulsive member,

wherein seals for airtight sealing are provided between the valve piston and the plunger and between the valve piston and the power piston, and each of the seals is formed of a rolling seal, and

wherein the control valve comprises a vacuum valve having a loop type valve seat for opening and closing a communication passage between the constant pressure chamber and the variable pressure chamber, and an annular atmospheric valve for opening and closing a communication passage between the variable pressure chamber and the outside of the body shell on the side radially inwardly of the vacuum valve, and that the sealing diameter of the atmospheric valve is approximate to the shaft diameter of the valve piston at its portion exposed to the atmosphere.

Preferably, the power piston comprises a reaction piston for pressing a master cylinder piston of the hydraulic brake device, and for receiving the pressure produced in a master cylinder, and a locking device for fixing the relative position between the input member and the master cylinder piston at a position where the power piston has reached the terminal point of its boosting function, and maintaining the fixed state of the relative position when the power piston moves beyond the terminal point of the boosting function, wherein the reaction force of the reaction piston can be borne at the front end of the plunger through the locking device.

Also it is preferable to provide a reaction force transmission restricting means for elastically separating the locking device from the plunger to create an axial gap between the radially inner front end of the valve piston and the rear end of the locking device when the booster device is in its initial state.

In this invention, since the seals for airtight sealing to be provided between the valve piston and the plunger and between the valve piston and the power piston are formed of rolling seals, which have no slide resistance, no force is transmitted from the plunger or power piston, so that the valve piston actuates smoothly. This stabilizes the output and makes return of the valve piston accurate.

Further, in the arrangement in which the control valve comprises the vacuum valve and the atmospheric valve, which is provided radially inwardly of the vacuum valve, it is possible to independently set the sealing diameter of the atmospheric valve and the position and sealing diameter of the vacuum valve, so that it is possible to improve the operating characteristics by reducing the diameter of the valve piston and increasing the area on which the pressure difference acts.

As shown in the abovesaid patent publication, if the vacuum valve and the atmospheric valve are coaxially provided, the differential pressure between the constant pressure chamber and the variable pressure chamber cannot be applied to the valve piston at its portion radially inwardly of the sealing diameter of the vacuum valve. But by arranging the vacuum valve at a position offset from the axis of the valve piston, this trouble is solved, so that it is possible to ensure a large area difference between the pressure bearing surfaces for bearing the pressures in the constant pressure chamber and the variable pressure chamber opposite to each other by reducing the outer diameter of the valve piston. Further, since the sealing diameter of the atmospheric valve and the diameter of the portion of the valve piston that is exposed to the atmosphere are approximate to each other, it is possible to substantially prevent the valve piston from being subjected to a pressure difference other than the pressure difference between the constant pressure chamber and the variable pressure chamber (the difference between the pressure in the constant pressure chamber and the atmospheric pressure). Thus, the operating characteristics of the valve piston improve, so that the output stabilizes.

By making it possible to obtain both of the effect of smoother actuation of the valve piston by use of the rolling seals and the effect of improved operating characteristics due to increased pressure bearing area difference of the valve piston and approximation of the sealing diameter of the atmospheric valve and the diameter of the portion of the valve piston that is exposed to the atmosphere, the output of the booster device will further stabilize.

Besides, in the arrangement in which the reaction piston and the locking device are provided, it is possible to prevent the brake pedal from being pushed in without accompanying any increase in the reaction force when the driver further step in the brake pedal after the power piston has reached the terminal point of the boosting function.

Further, in the arrangement in which the reaction force transmission means is provided for elastically separating the locking device from the plunger to create an axial gap between the radially inner front end of the valve piston and the rear end of the locking device when the booster device is in the initial state, advancing behaviors of the valve piston for opening the vacuum valve will not be hindered by the locking device, so that it is possible to prevent pressure increase in the variable pressure chamber when hydraulic pressure control is done and excess brake fluid is returned from the brake circuit to the master cylinder, and to prevent the resulting relative displacement between the valve piston and the power piston.

### BRIEF DESCRIPTION OF THE DRAWINGS

Other features and objects of the present invention will become apparent from the following description with reference to the accompanying drawings, in which:

FIG. 1 is a view showing an example of the basic structure of a vehicle hydraulic brake device having a negative pressure type booster device;

FIG. 2 is a sectional view showing a portion of an embodiment of the negative pressure type booster device of this invention; and

FIG. 3 is an enlarged view showing a portion of FIG. 2.

### DETAILED DESCRIPTION OF THE PREFERRED EMBODIMENT

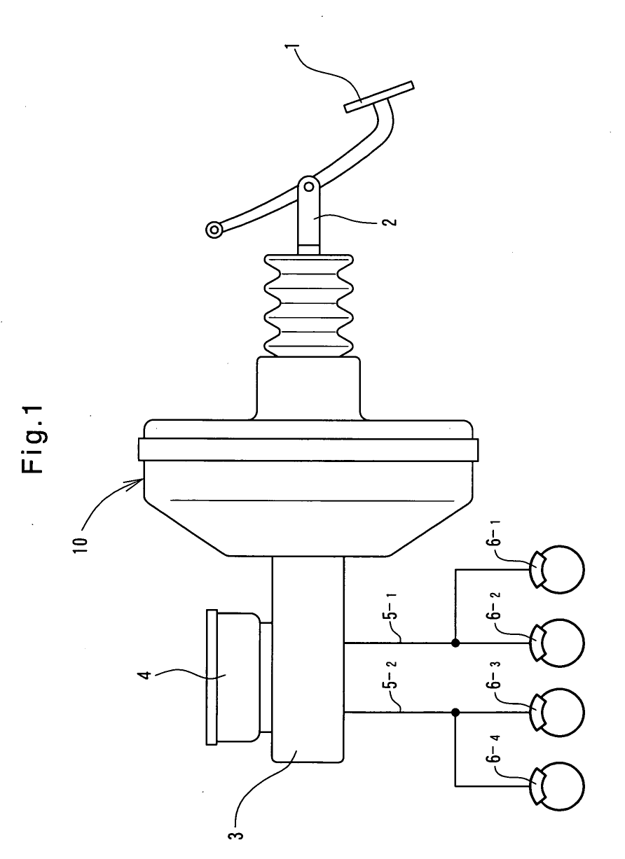

Below, the embodiment of this invention will be described based on the attached figures. FIG. 1 shows an example of a basic structure of a vehicle hydraulic brake device having a negative pressure type booster device. It includes a brake pedal 1, an input shaft 2 connected to the brake pedal, a tandem master cylinder 3, a reservoir 4 which the tandem master cylinder 3 has, brake circuits 5-1, 5-2 connected to respective output ports of the tandem master cylinder 3, wheel cylinders 6-1 to 6-4, and a negative pressure type booster device 10.

The negative pressure type booster device 10 is adapted to amplify brake operating force input from the brake pedal 1 through the input shaft 2, and transmit it to a master cylinder piston of the tandem master cylinder 3. Thus, hydraulic pressure corresponding to the brake operating force is produced in the respective master cylinder hydraulic pressure chambers of the tandem master cylinder 3. This hydraulic pressure is supplied to the wheel cylinders 6-1 to 6-4 to impart braking force to the respective road wheels of the vehicle.

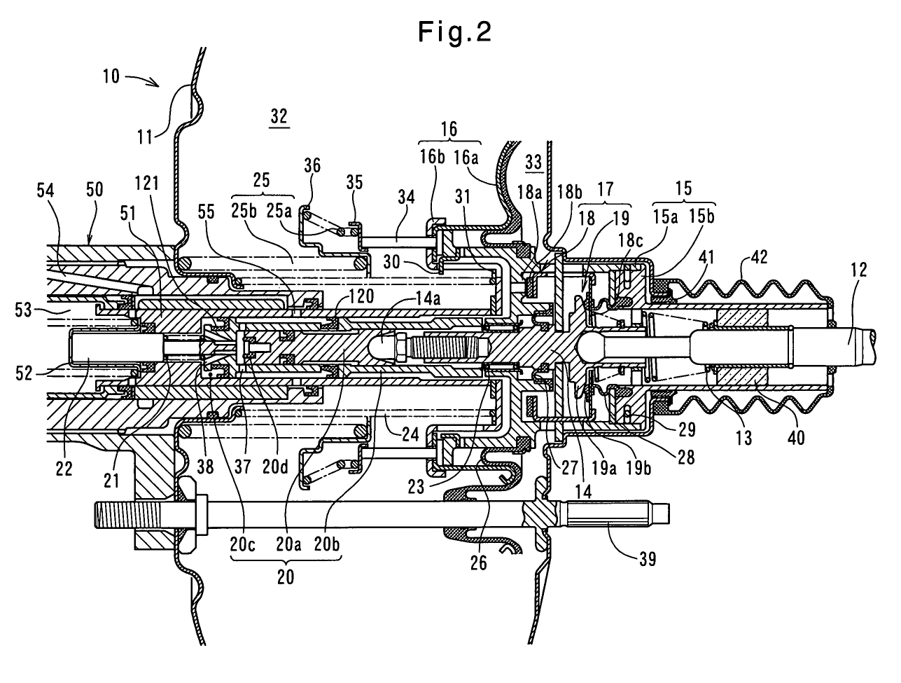

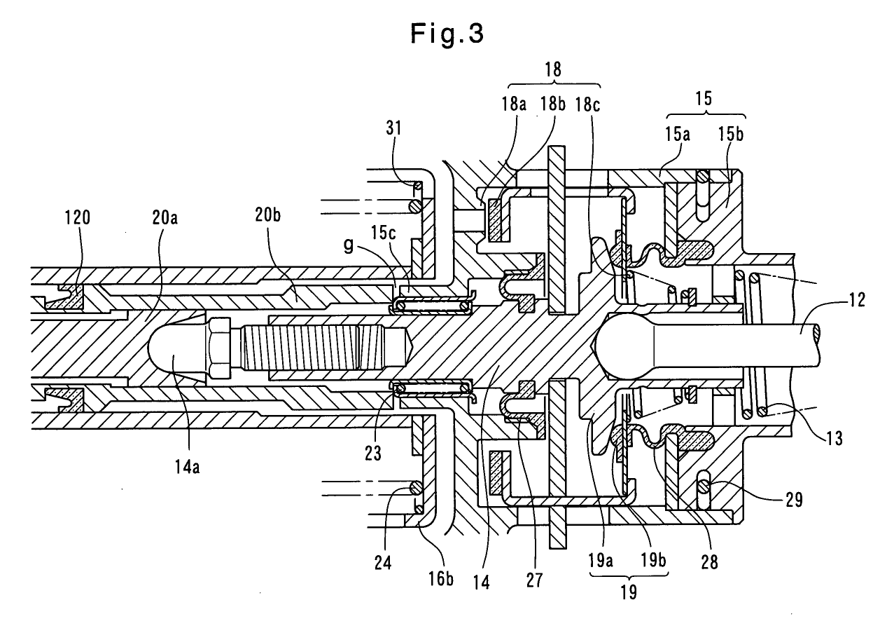

FIGS. 2 and 3 show the details of an example of this negative pressure type booster device 10. It includes a body shell 11, an input shaft 12, a return spring 13 for the input shaft 12, a plunger 14 coupled to the input shaft 12, a valve piston 15 on the input side, a power piston 16 which is an output member, a control valve 17 in which a vacuum valve 18 and an atmospheric valve 19 are combined, a locking mechanism 20, a reaction piston 22 arranged in front of the locking mechanism 20 through a jumping spring 21, a suspension spring set 23 arranged between the plunger 14 and the locking mechanism 20, a return spring 24 for the power piston 16, a spring set 25 arranged between the valve piston 15 and the body shell 11, and rolling seals 26, 27 and 28.

The valve piston 15 comprises a piston front portion 15a and a piston rear portion 15b, which are coupled to each other through a joint member 29. The piston front portion 15a includes at its front end an outer cylindrical portion and an inner cylindrical portion, both not numbered.

Further, the power piston 16 comprises a partitioning wall 16a in which a diaphragm and a power plate are combined, and an output transmission member 16b. In a cylindrical portion provided on the inner diameter side of the partitioning wall 16a, the front portion of the valve piston 15 (the front end of the piston front portion 15a) is loosely inserted so as to be concentric with the power piston 16 and relatively movable in the axial direction.

Further, a stopper 30 and a ring 31 are provided for restricting the maximum amount of the relative movement between the valve piston 15 and the power piston 16.

The interior (chamber) of the body shell 11 is partitioned into a constant pressure chamber 32 and a variable pressure chamber 33 by the partitioning wall 16a and the valve piston 15. The body shell 11 serves as a shell for the constant pressure chamber 32 and the variable pressure chamber 33. The constant pressure chamber 32 is connected to a negative pressure source (not shown) such as an engine intake manifold. Into the variable pressure chamber 33, atmospheric air is introduced while the negative pressure type booster device 10 is operating.

The vacuum valve 18 of the control valve 17 comprises a loop type valve seat 18a provided at an intermediate portion in the radial direction of the valve piston 15, a valve body 18b actuated by the displacement of the plunger 14, and a spring 18c for biasing the valve body 18b in the valve closing direction. On the other hand, the atmospheric valve 19 comprises a valve body 19a provided on the plunger 14 and an annular valve seal 19b to be brought into and out of contact with the valve body 19a. The seal diameter of the atmospheric valve 19 is substantially equal to the shaft diameter of the portion of the valve piston 15 exposed to the atmosphere. Further, the spring 18c also serves to maintain a closed state of the atmospheric valve 19 by moving the valve seal 19b, which is integral with the rolling seal 28, following the movement of the plunger 14 until the vacuum valve 18 closes.

The locking mechanism 20 comprises a locking valve 20a, a locking piston 20b liquid-tightly and axially slidably fitted on the locking valve 20a, and a locking chamber 20c into which the front surface of the locking valve 20a protrudes.

As shown in FIG. 3, between the front end 15c of the inner cylindrical portion of the valve piston 15 and the rear end of the locking piston 20b, there exists a slight gap g in the initial state. The suspension spring set 23 is arranged between the plunger 14 and the locking piston 20b. The suspension spring set 23 serves as a reaction force transmission restricting means to allow smooth opening of the vacuum valve 18 due to advancement of the valve piston 15 even if the locking piston 20b shows returning behaviors.

As the spring set 25, one in which a first spring 25a and a second spring 25b which are different in characteristics are combined in series is used. As shown in FIG. 2, a retainer 35 is mounted on a support pillar 34 extending through the output transmission member 16b of the power piston 16, with the first spring 25a arranged between the retainer 35 and a retainer 36 and the second spring 25b between the retainer 36 and the body shell 11.

As described above, by using springs having different characteristics in combination in series, in the initial stage of brake operation, the deflection of the first spring 25a occurs first, so that the load on the springs gradually increases. After the first spring 25a has been subjected to deflection restriction by the retainers 35 and 36, the second spring 25b deflects, so that increase in the load on the springs steepens. Thus, the relation between the pedal stroke and the output hydraulic pressure approaches an ideal curve, so that the brake feeling improves.

The rolling seal 26 is formed integral with the diaphragm of the partitioning wall 16a, airtightly sealing between the partitioning wall 16a and the valve piston 15.

Further, the rolling seal 27 airtightly seals between the plunger 14 and the valve piston 15 in front of the atmospheric valve 19.

Further, the rolling seal 28 airtightly seals between the plunger 14 and the valve piston 15 in the rear of the atmospheric valve 19 too.

Into the body shell 11, part of a master cylinder (which is not limited to a tandem master cylinder) 50 is inserted from front. The master cylinder piston 51 of the master cylinder 50 is liquid-tightly and axially slidably fitted on the outer periphery of the locking piston 20b to directly push the master cylinder piston 51 with the power piston 16.

The locking valve 20a is supported by a tip member 14a of the plunger 14. The reaction piston 22 is supported by a retainer 52 supported by the master cylinder piston 51. Thus, when the brake pedal is stepped in and hydraulic pressure is generated in a master cylinder hydraulic pressure chamber 53, the reaction piston 22 is pushed rightwardly in the figure and its force is adapted to be transmitted to the brake pedal through the input shaft 12 as reaction force.

Further, a communication passage 54 to the reservoir (not shown) leads to the locking chamber 20c of the locking mechanism 20 through a communication passage 55 provided in the master cylinder piston 51 and communication passages 37 and 38 provided in the locking piston 20b.

39 in the figures is a mounting shaft which also serves as a reinforcing material, 40 is a filter for purifying atmospheric air introduced into the variable pressure chamber 33, 41 is a slide seal for sealing between the portions of the body shell 11 and the valve piston 15 that are exposed to the atmosphere (no large surface pressure is required for this slide seal 41, so that slide resistance due to it can be ignored), and 42 is a protection boot for protecting the portion of the valve piston 15 exposed to the atmosphere.

In the thus structured negative pressure type booster device 10, while not in operation, when the brake pedal is not stepped in, the vacuum valve 18, which opens and closes the passage between the constant pressure chamber 32 and the variable pressure chamber 33, is open, and the atmospheric valve 19, which opens and closes the passage between the constant pressure chamber 33 and the body shell 11, is closed. Thus, the pressure in the variable pressure chamber 33 is equal to the pressure in the constant pressure chamber 32, so that the power piston 16 and the valve piston 15 are at a stop at the illustrated positions.

Next, when the brake pedal is stepped in and the input shaft 12 is pushed in leftwardly in the figure, the vacuum valve 18 is closed first, and later, the atmospheric valve 19 opens. Thus, atmospheric air is introduced from outside the body shell 11 into the variable pressure chamber 33, so that a pressure difference corresponding to the brake operating force is generated between the constant pressure chamber 32 and the variable pressure chamber 33. This pressure difference is applied to the valve piston 15, so that advancing thrust force is produced in the valve piston 15. Thus, the valve piston 15 moves to a point where the advancing thrust force due to the pressure difference balances with the reaction force from the spring set 25.

Further, due to the pressure difference between the constant pressure chamber 32 and the variable pressure chamber 33, the power piston 16 also produces advancing thrust force (amplified force), and with the amplified force, the power piston 16 presses the master cylinder piston 51. Thus, hydraulic pressure corresponding to the brake operating force is produced in the master cylinder hydraulic pressure chamber 53. This hydraulic pressure is supplied to the wheel cylinders of the brake circuits and braking of the respective road wheels is carried out. Further, at this time, the reaction piston 22 is pushed rightwardly in the figure under the hydraulic pressure in the master cylinder hydraulic pressure chamber 53. This force is transmitted to the brake pedal through the locking valve 20a, plunger 14 and input shaft 12 as reaction force.

In the locking mechanism 20, when the boosting ability (assisting force) of the booster device reaches or approaches the limit, a valve body 20d at the front end of the locking valve 20a closes a passage 38 provided in the locking piston 20b, sealing brake fluid in the locking chamber 20c (the volume of which has increased due to relative movement between the power piston 16 and the valve piston 15). Thus, relative movement between the input shaft 12 and the master cylinder piston 51 stops, so that a situation is prevented in which when the driver additionally steps in the brake pedal from this position, the brake pedal moves in without accompanying increased reaction force. Since the locking mechanism 20 stops the relative movement using hydraulic pressure, compared with one using air pressure, it is superior in reliability. Even though brake fluid is sealed in the locking chamber 20c, since the reaction piston 22 can move to the balance point of the forces applied to both ends opposite to each other, there will be no problem in transmitting the reaction force to the brake pedal.

When the brake operation is released, the atmospheric valve 19 closes and the vacuum valve 18 opens. Thus, the pressure difference between the constant pressure chamber 32 and the variable pressure chamber 33 disappears, so that under the force of the return spring 24 and the spring set 25, the power piston 16 and the valve piston 15 will be pushed back and return to the initial state.

In the above stroke, the valve piston 15 smoothly operates without being affected by the movement of the plunger 14 and the power piston 16 because airtight sealing between the valve piston 15 and the power piston 16 and between the power piston 15 and the plunger 14 is performed by the rolling seals 26, 27 and 28. Thus, the output of the negative pressure type booster device 10 stabilizes, so that accurate return of the valve piston 15 is achieved.

Further, when control by electronic stability control (ESC) or antilock brake system (ABS) is carried out, and excess brake fluid is returned from the brake circuits to the master cylinder hydraulic pressure chamber 53, the vacuum valve 18 smoothly opens, so that pressure rise in the variable pressure chamber 33 is prevented.

When hydraulic control by electronic control is carried out and excess brake fluid is returned from the brake circuits into the master cylinder hydraulic pressure chamber 53, the power piston 16, which has advanced, will retract, so that the air in the variable pressure chamber 33 is compressed, and the pressure in the variable pressure chamber 33 rises. If this is left as it is, it is impossible to maintain the pressure difference between the constant pressure chamber 32 and the variable pressure chamber 33 to a value corresponding to the brake operation. Thus, at this time, it is necessary to quickly open the vacuum valve 18 to lower the pressure in the variable pressure chamber 33 to the original pressure (pressure before it rises).

For this requirement, if the rear end of the locking piston 20b, which is showing a return behavior, is in abutment with the front end 15c of the inner cylindrical portion of the valve piston 15, smooth opening of the vacuum valve 18 would be impaired. In the illustrated negative pressure type booster device 10, the gap g is ensured between the locking piston 20b and the valve piston 15 by providing the suspension spring set 23. Thus, when the power piston 16 is pushed back and the pressure in the variable pressure chamber 33 rises, even if slide resistance of seals 120 and 121 provided between the master cylinder piston 51, which is operatively linked to the power piston 16, and the locking piston 20b acts, the valve piston 15 will be pushed forward without a hitch under the pressure difference between the constant pressure chamber 32 and the variable pressure chamber 33, so that opening of the vacuum valve 18 is not impaired.

Besides, since the vacuum piston 18 is arranged at a position offset from the axis of the valve piston 15, and the seal diameter of the atmospheric valve 19 and the diameter of the portion of the valve piston 15 exposed to the atmosphere are approximated to each other, it is possible to make the shaft diameter of the portion of the valve piston 15 exposed to the atmosphere as small as possible, thereby ensuring a large area difference between the opposed pressure receiving surfaces of the valve piston 15. Further, since the seal diameter of the atmospheric valve 19 and the diameter of the portion of the valve piston 15 exposed to the atmosphere are approximated to each other, the valve piston 15 will hardly be subjected to a pressure difference other than the pressure difference between the constant pressure chamber 32 and the variable pressure chamber 33 (difference between the constant pressure chamber 32 and the atmospheric pressure), so that the operating properties of the valve piston 15 improve. This stabilizes the output.

As described above, in the negative pressure type booster device for a hydraulic brake device of this invention, airtight sealing between the power piston and the valve piston, which can move relative to the power piston, and between the valve piston and the plunger is assured by means of rolling seals, so that actuation and return of the valve piston are smooth and accurate, which stabilizes the output.

Further, in the arrangement in which the vacuum valve is provided at a position offset from the axis of the valve piston to approximate the sealing diameter of the atmospheric valve to the diameter of the portion of the valve piston exposed to the atmosphere, the operating characteristics of the valve piston improve, so that the output stabilizes.

Further, in the arrangement having the locking device, when the boosting ability (assisting ability) of the booster device reaches or approaches its limit, brake fluid is sealed in the locking chamber, so that the relative movement position between the input shaft and the master cylinder piston is fixed. This prevents the brake pedal from being pushed in without accompanying increase in the reaction force when the driver further steps in the brake pedal from this position.

Besides, in the arrangement in which the reaction force transmission restricting means is provided between the plunger and the locking device, a gap is ensured between the front end of the inner cylindrical portion of the valve piston and the rear end of the locking piston even when the locking piston of the locking device shows returning behaviors, so that smooth opening of the vacuum valve is ensured. Thus, during hydraulic control by electronic control, even if the power piston is pushed back by excess brake fluid, pressure increase in the variable pressure chamber, and variation in the relative position between the power piston and the valve piston due to the pressure increase are suppressed, so that the output stabilizes more.

What is claimed is:

1. A negative type booster device for a hydraulic brake device comprising an input member, a power piston, a valve piston having a front end concentrically inserted in said power piston, a constant pressure chamber and a variable pressure chamber separated from each other by said power piston, a body shell forming the outer shell of said constant pressure chamber and said variable pressure chamber, and a control valve activated by brake operating force applied through said input member to selectively bring said variable pressure chamber into communication with the outside of said body shell and said constant pressure chamber, said control valve changing the pressure in said variable pressure chamber to a value corresponding to the input, thereby producing a pressure difference between said constant pressure chamber, which is connected to a negative pressure source, and said variable pressure chamber to amplify the output by applying said pressure difference to said power piston,
wherein said input member is coupled to a plunger, said plunger and said control valve are provided in said valve piston, said valve piston and said power piston are combined so as to be movable axially relative to each other such that each of them produces an advancing thrust force under the pressure difference between said constant pressure chamber and said variable pressure chamber, and said valve piston is biased in the retracting direction by an elastic repulsive member, and
wherein seals for airtight sealing are provided between said valve piston and said plunger and between said valve piston and said power piston, and each of said seals is formed of a rolling seal.

2. A negative type booster device for a hydraulic brake device comprising an input member, a power piston, a valve piston having a front end concentrically inserted in said power piston, a constant pressure chamber and a variable pressure chamber separated from each other by said power piston, a body shell forming the outer shell of said constant pressure chamber and said variable pressure chamber, and a control valve activated by brake operating force applied through said input member to selectively bring said variable pressure chamber into communication with the outside of said body shell and said constant pressure chamber, said control valve changing the pressure in said variable pressure chamber to a value corresponding to the input, thereby producing a pressure difference between said constant pressure chamber, which is connected to a negative pressure source, and said variable pressure chamber to amplify the output by applying said pressure difference to said power piston,
wherein said input member is coupled to a plunger, said plunger and said control valve are provided in said valve piston, said valve piston and said power piston are combined so as to be movable axially relative to each other such that each of them produces an advancing thrust force under the pressure difference between said constant pressure chamber and said variable pressure chamber, and said valve piston is biased in the retracting direction by an elastic repulsive member,
wherein seals for airtight sealing are provided between said valve piston and said plunger and between said valve piston and said power piston, and each of said seals is formed of a rolling seal, and
wherein said control valve comprises a vacuum valve having a loop type valve seat for opening and closing a communication passage between said constant pressure chamber and said variable pressure chamber, and an annular atmospheric valve for opening and closing a communication passage between said variable pressure chamber and the outside of said body shell on the side radially inwardly of said vacuum valve, and that the sealing diameter of said atmospheric valve is approximate to the shaft diameter of said valve piston at its portion exposed to the atmosphere.

3. A negative type booster device for a hydraulic brake device as claimed in claim 1 wherein said power piston comprises a reaction piston for pressing a master cylinder piston of the hydraulic brake device, and for receiving the pressure produced in a master cylinder, and a locking device for fixing the relative position between said input member and said master cylinder piston at a position where said power piston has reached the terminal point of its boosting function, and maintaining the fixed state of the relative position when said power piston moves beyond said terminal point of the boosting function, wherein the reaction force of said reaction piston can be borne at a front end of said plunger through said locking device.

4. A negative type booster device for a hydraulic brake device as claimed in claim 2 wherein said power piston comprises a reaction piston for pressing a master cylinder piston of the hydraulic brake device, and for receiving the pressure produced in a master cylinder, and a locking device for fixing the relative position between said input member and said master cylinder piston at a position where said power piston has reached the terminal point of its boosting function, and maintaining the fixed state of the relative position when said power piston moves beyond said terminal point of the boosting function, wherein the reaction force of said reaction piston can be borne at a front end of said plunger through said locking device.

5. A negative type booster device for a hydraulic brake device as claimed in claim 3 further comprising a reaction force transmission restrictor for elastically separating said locking device from said plunger to create an axial gap between a radially inner front end of said valve piston and the rear end of said locking device when said booster device is in its initial state.

6. A negative type booster device for a hydraulic brake device as claimed in claim 4 further comprising a reaction force transmission restrictor for elastically separating said locking device from said plunger to create an axial gap between a radially inner front end of said valve piston and the rear end of said locking device when said booster device is in its initial state.
